(19) United States
(12) Patent Application Publication
(10) Pub. No.: US 2016/0257704 A1
(43) Pub. Date: Sep. 8, 2016

(54) FLAME-RETARDANT CELLULOSE ESTER PREPARATIONS

(71) Applicant: LANXESS Deutschland GmbH, Cologne (DE)

(72) Inventors: Heiko TEBBE, Dormagen (DE); Jan-Gerd HANSEL, Bergisch Gladbach (DE); Otto MAUERER, Leichlingen (DE)

(21) Appl. No.: 15/057,388

(22) Filed: Mar. 1, 2016

(30) Foreign Application Priority Data
Mar. 5, 2015 (EP) 15157773.1

(51) Int. Cl. C07F 9/6571; C08K 5/5313

(52) U.S. Cl. CPC C07F 9/657163; C08K 5/5313

(57) ABSTRACT

Flame retardant cellulose ester preparations include phosphorus-containing propionic acid derivatives as flame-retardant plasticizers.

The present invention relates to cellulose ester preparations comprising phosphorus-containing propionic acid derivatives as flame-retardant plasticizers.

### Background Information

Esters of cellulose with short-chain aliphatic carboxylic acids have long been used industrially as engineered/engineering materials. Typical examples of these cellulose esters are cellulose acetate, cellulose propionate, cellulose butyrate and also mixed esters, such as cellulose acetate propionate or cellulose acetate butyrate. Their methods of making and processing are known, for example from K. Balser, L. Hoppe, T. Eicher, M. Wandel, Astheimer and H. Steinmeier: “Cellulose Esters”, Ullmann's Encyclopedia of Industrial Chemistry Release 2005, Electronic Release, 7th ed., chap. 2. (“Organic Esters”), Wiley-VCH, Weinheim 2005.

Cellulose esters are processible into thermoplastic moulding compounds, foams, sheets, films, coatings, paints and fibres. Plasticizers are frequently added in order to improve the mechanical properties of the engineering/engineered material and to lower the processing temperature.

There are some applications, for example in the electrical and electronics sector, where the products formed from plasticized cellulose ester preparations are expected to comply with certain flame-retardancy requirements. This is typically accomplished by using a plasticizer which is also as flame retardant. Prior art examples of such flame-retardant plasticizers are aryl phosphates, such as triphenyl phosphate (cf. U.S. Pat. No. 1,981,312) or resorcinol his(diphenyl phosphate) (cf. WO 9205219 A1), alkyl phosphates, such as triethyl phosphate (cf. U.S. Pat. No. 2,617,737) or alkylene his(phosphate)s (cf. U.S. Pat. No. 2,782,128) and chloroalkyl phosphates, such as tris(chioroethyl) phosphate (cf. U.S. Pat. No. 2,618,568), or halogenated phthalic esters (cf. U.S. Pat. No. 2,062,403).

Aryl phosphates and particularly triphenyl phosphate may be of outstanding importance here because, as well as flame retardancy, they confer further useful properties on as cellulose ester preparation, for example a reduced rate of water vapour transmission (cf, US 2003/0118754 A1). However, prior art flame-retardant plasticizers have certain disadvantages. To wit, the compatibility of aryl phosphates with cellulose esters is limited. One possible consequence is that the plasticizer exudes from the cellulose ester preparation. To control exudation, aryl phosphates often have to be used together with traditional plasticizers, which do not have any flame-retardant properties. Plasticizing alkyl phosphates often also have excessive volatility, reducing for example the dimensional stability of products made from the cellulose ester preparation.

A further disadvantage with some flame-retardant plasticizers is considered to be their potentially disadvantageous effect on man and the environment Triphenyl phosphate is very toxic to aquatic life with long-lasting effects (GHS classification H410). Tris(chloroethyl) phosphate is suspected of causing cancer (GHS classification H351). Brominated plasticizers, for example tetrabrominated bis(2-ethylhexyl) phthalate, are suspected of persistence and bioaccumulation. Cellulose ester preparations comprising such plasticizers are less and less accepted in consumer applications.

There is accordingly a need for flame-retardant plasticizers that are highly compatible with cellulose esters, and do not contain any halogen compounds or any aryl phosphates. Typical properties of plastics based on cellulose esters, for example transparency and light-fastness, should ideally be affected as little as possible.

U.S. Pat. No. 4,137,201 already discloses cellulose ester preparations containing a thermal stabilizer comprising a combination of certain 9,10-dihydro-9-oxa-10-phosphaphenanthrene 10-oxide derivatives, antioxidants and acid-binding epoxy compounds.

These thermal stabilizers are employed in amounts of 0.10 to 1.0 part, preferably 0.10-0.30 part, based on 100 pans of cellulose ester, Thermal stabilizers are substances that are incorporated in plastics compositions in order to counteract degradation of the aesthetic or mechanical properties of these plastics compositions due to heat during the product life cycle.

The problem addressed by the present invention is that of providing a flame-retardant plasticized cellulose ester preparation that overcomes known disadvantages.

### SUMMARY

It was found that by using certain, phosphorus-containing propionic acid derivatives, cellulose ester preparations may be produced that have flame-retardant properties in addition to being plasticized. Surprisingly, the novel cellulose ester preparations require no additional plasticizers and attain a level of flame retardancy equivalent to other materials without any need for halogen compounds or aryl phosphates.

The present invention accordingly provides a cellulose ester preparation that includes
a) at least one cellulose ester, and
b) at least one phosphorus-containing propionic acid derivative of formula (I)

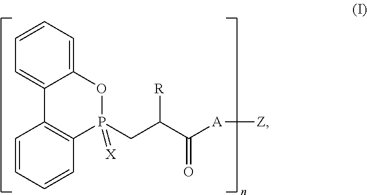

where
X represents oxygen or sulphur, preferably oxygen,
R represents hydrogen or methyl, preferably hydrogen,
A represents oxygen or NH, preferably oxygen,
Z represents an n-valent saturated, straight-chain or branched, aliphatic hydrocarbyl moiety of 1 to about 20 carbon atoms which may optionally be interrupted by one or more heteroatoms from the series oxygen and sulphur, or an n-valent 5- or 6-membered heterocyclic ring which contains one to three nitrogen atoms as heteroatoms and may optionally be substituted by one or more identical or different substituents, and
n represents an integer from 1 to 4.

### DETAILED DESCRIPTION OF THE INVENTION

Possible substituents for the optionally substituted n-valent 5- or 6-membered heterocyclic ring Z include C₁-C₄ alkyl moieties, in particular methyl and ethyl, C₁-C₄ alkoxy moieties, in particular methoxy and ethoxy, and C₁-C₄alkylene moieties, in particular methylene and ethylene.

The cellulose ester preparation of the present invention preferably contains

at least one phosphorus-containing propionic acid derivative of formula (I)
where
represents an n-valent saturated, straight-chain or branched, aliphatic hydrocarbyl moiety of 1 to about 10 carbon atoms which may optionally be interrupted by one to four heteroatoms from the series oxygen and sulphur, or an n-valent 5- or 6-membered heterocyclic ring which contains one to three nitrogen atoms as heteroatoms and may optionally be substituted by one to three identical or different substituents.

The cellulose ester preparation of the present invention more preferably contains

at least one phosphorus-containing propionic acid derivative of formula (I)
where
Z represents an n-valent saturated, straight-chain or branched, aliphatic hydrocarbyl moiety of 1 to 6 carbon atoms which may optionally be interrupted by one or two oxygen atoms, or an n-valent 5- or 6-membered heterocyclic ring which contains one to three nitrogen atoms as heteroatoms and may optionally be substituted by one to three identical or different substituents.

In the very particularly preferred embodiments (1a) to (1d), the cellulose ester preparation of the present invention contains at least one phosphorus-containing propionic acid derivative of formula (I) where the moieties X, R, A and Z and the index n each have the meanings specified for the particular embodiment in the following table:

| Embodiment | X | R | A | Z | n |
|---|---|---|---|---|---|
| (1a) | O | H | O | methyl, ethyl, n-propyl, isopropyl, n-butyl, | 1 |
| | | | | isobutyl, 2-ethylhexyl, isooctyl, n-nonyl, | |
| | | | | isononyl, 2-propylheptyl, n-decyl or isodecyl | |
| (1b) | O | H | O | —CH₂CH₂—, —CH₂CH₂CH₂—, —CH₂CH(CH₃)—, | 2 |
| | | | | —CH₂CH₂CH₂CH₂—, —CH₂CH₂CH(CH₃)—, | |
| | | | | —CH₂C(CH₃)₂CH₂—, —CH₂CH₂CH₂CH₂CH₂CH₂— | |
| | | | | or —CH₂CH₂—O—CH₂CH₂— | |
| (1c) | O | H | O | (—CH₂)₃CCH₃ or | 3 |
| | | | | 1,3,5-tris(ethylene)-1,3,5-triazine-2,4,6-trione | |
| (1d) | O | H | O | (—CH₂)₄C | 4 |

The cellulose ester preparation of the present invention may contain the phosphorus-containing propionic acid derivatives of formula (I) individually or in any desired mixture. Some of the formula (I) propionic acid derivatives present in the cellulose ester preparation of the present invention are known (cf, for instance DE-A 26 46 218 and Organic. Utters 2005, Vol. 7, No. 5, Supplementary Information S8).

The phosphorus-containing propionic acid derivatives of embodiment (1a), where X represents oxygen, R represents hydrogen. A represents oxygen, n represents 1 and Z represents 2-ethylhexyl, isooctyl, n-nonyl, isononyl, 2-propylbeptyl, n-decyl or isodecyl in formula (I), are novel and likewise form part of the subject-matter of the present invention.

The phosphorus-containing propionic acid derivatives of embodiment (1b), where X represents oxygen, R represents hydrogen, A represents oxygen, n represents 2 and Z represents —CH₂CH₂—, —CH₂CH₂CH₂—, —CH₂CH(CH₃)—, —CH₂CH₂CH₂CH₂—, —CH₂CH₂CH(CH₃)—, —CH₂C(CH₃)CH₂—, —CH₂CH₂CH₂CH₂CH₂CH₂— or —CH₂CH₂—O—CH₂CH₂— in formula (I), are likewise novel and part of the subject-matter of the present invention.

The propionic acid derivatives of formula (I) may be useful as flame-retardant plasticizers for cellulose ester preparations. The present invention accordingly also provides for the use of phosphorus-containing propionic acid derivatives of formula (I) as flame retardants with plasticizing properties for cellulose ester preparations.

The phosphorus-containing propionic acid derivatives of formula (I) where n represents 1 may be obtainable in a conventional manner, for example by the methods described in DEA 26 46 218 and Organic Letters 2005, Vol. 7, No. 5, Supplementary Information S8, e.g. by reacting 9,10-dihydro-9-oxa-10-phosphaphenanthrene 10-oxide with appropriate acrylic esters at a temperature of 35 to 65° C. under atmospheric pressure.

The starting 9,10-dihydro-9-oxa-10-phosphaphenanthrene 10-oxide and acrylic esters are commercially available.

The phosphorus-containing propionic acid derivative of formulae (I) where n represents 2, 3 or 4 may be obtainable in a similar manner by reacting 9,10-dihydro-9-oxa-10-phosphaphenanthrene 10-oxide with the acrylic esters of appropriate bi-, tri- or tetravalent polyols, as for example known from European Polymer Journal, 2011, Volume 47, pages 1081-1089.

The cellulose esters present in the cellulose ester preparation of the present invention preferably comprise cellulose acetate, cellulose triacetate, cellulose propionate, cellulose butyrate, cellulose acetate propionate or cellulose acetate butyrate, cellulose acetate phthalate, carboxymethylcellulose acetate, carboxymethylcellulose butyrate or a preparation from mixtures of these cellulose esters, It is particularly preferable for a cellulose acetate preparation.

The degree of substitution (DS) of the cellulose esters may be 1.0 to about 3.0 acyl groups per anhydroglucose unit. DS is quantifiable by methods known to a person skilled in the art, for example by titrating the esterified acyl groups as per ASTM D 871-96 and computing the DS from the acyl group content.

The preparation according to the present invention preferably concerns a cellulose acetate preparation having a degree of substitution in the range from 2.0 to 3,0 acetyl groups per anhydroglucose unit.

The preparation according to the present invention contains in general about 5 to about 60 parts by weight of phosphorus-containing propionic acid derivatives of formula (I) based on 100 parts by weight of cellulose ester, Preferably, the preparation according to the present invention contains about 10 to about 50 parts by weight of the phosphorus-containing propionic acid derivative of formula (1) based on 100 parts by weight of cellulose ester.

The cellulose ester preparation of the present invention may optionally further contain one or more auxiliary and/or added-substance materials, or else not in any one particular case. Such auxiliaries or added-substance materials include for example:

1. Plasticizers, for example alkyl esters of benzoic acid, phthalic acid, terephthalic acid, cyclohexane-1,2dicarboxylic acid, trimellitic acid, succinic acid, adipic acid, sebacic acid, azelaic acid, citric acid, acetylcitric acid, phosphoric acid, alkylene esters of benzoic acid, isosorbitol esters; polyesters obtainable from dials, dicarboxylic acids and optionally monools and monocarboxylica acids; epoxidized fatty acid esters, glycerol esters of acetic acid and fatty acids, phenyl esters of alkanestilphonic acids, or mixtures thereof.

2. UV stabilizers, for example benzotriazoles, triazines, hydroxybenzophenones, benzoxazinones, resorcinol monobenzoates, salicylates, cinnamic acid derivatives, oxanilides, hydroxybenzoic esters, sterically hindered amine light absorbers (“HALS”), or mixtures thereof.

3. Thermal stabilizers and/or antioxidants, for example sterically hindered phenols, sterically hindered amines, epoxides of natural oils, organic phosphites, or mixtures thereof.

4. Colorants, for example soluble dyes, organic pigments, inorganic pigments, or mixtures thereof.

5. Fillers, for example inorganic fillers based on silicon dioxide, aluminium oxide, aluminium oxide hydroxide, boehmite, silicates, talc or organic fillers based on wood or vegetable fibres, or mixtures thereof.

6. Polymers, for example polyacrylates, polymethacrylates, ethylene-vinyl acetate copolymers, or mixtures thereof.

7. Blowing agents, for example physical blowing agents such as carbon dioxide, nitrogen, propane, butane, pentane, ethanol, propanol or chemical blowing agents such as citric acid/bicarbonate mixtures.

8. Scents, biocides, pesticides, processing aids and/or lubricants.

9. Flame retardants, for example those from the series of

a) organic phosphorus compounds, for example triethyl phosphate, aliphatic bisphosphates, dimethyl methanephosphonate, diethyl ethanephosphonate, dimethyl propanephosphonate, oligomeric phosphates or phosphonates, hydroxyl-containing phosphorus compounds, di methyl-1,3,2-dioxaphosphorinane 2-oxide derivatives, 6H-dibenzo[c,e][1,2]oxaphosphorine 6-oxide derivatives, e.g. N¹,N²-bis(6-oxido-6H-dibenzo[c,e][1,2]oxaphosphorin-6-yl)-1,2-ethanediamine, phosphazeties,

b) organic and inorganic, salt-type phosphorus compounds, for example ammonium phosphate, ammonium polyphosphate, ethylenediamine phosphate, melamine phosphate, melamine polyphosphate, metal-melainine polyphosphates, metal salts of dialkylphosphinic acids, metal salts of alkanephosphonic acids,

c) nitrogen compounds, for example melamine, melamine cyanurate, and

e) inorganic flame retardants, for example aluminium hydroxide, boebmite, magnesium hydroxide, expandable graphite or clay minerals.

The cellulose ester preparation of the present invention may be obtainable by the familiar methods of processing cellulose esters. It may be, for example, obtainable in a procedure wherein the cellulose ester, the phosphorus-containing propionic acid derivative of formula (I) and optionally one or more auxiliary and/or added-substance materials are intimately mixed, preferably at a temperature of about 0 to about 100° C., and the resulting mixture may then be homogenized, preferably at a temperature of about 100 to about 280° C., Homogenization may utilize the customary assemblies, for example single- or twin-screw extruders, rolls or kneaders. The cellulose ester preparation thus obtained may be granulated, pelletized or otherwise formatted in further processing steps.

In an alternative method of production, the components of the cellulose ester preparation may be homogenized in the presence of a solvent. Suitable solvents include methanol, ethanol, isopropanol, acetone, butanone, ethyl acetate, butyl acetate, dichloromethane, toluene and mixtures thereof.

The as-obtained solution may be directly usable for production of thermoplastic films, sheets, coatings and paints. The as-obtained solution may for example be converted to any desired form, for example as liquid film spread out over a surface or distributed in a three-dimensional body. The solvent evaporates to leave a thermoplastic cellulose acetate film in the shape of this surface or three-dimensional mould.

The solutions thus obtained likewise form part of the subject-mater of the invention. The solutions of the present invention preferably contain at least one organic solvent, in particular at least one organic solvent selected from the series methanol, ethanol, isopropanol, acetone, butanone, ethyl acetate, butyl acetate, dichloromethane and toluene.

The cellulose ester preparation of the present invention may be further processible by the familiar methods of processing thermoplastic materials, for example to produce flame-retarded mouldings, sheets, films, coatings, paints and fibres. It may preferably be further processed by extrusion or injection moulding. It may likewise be preferable to process same by pressing whereby a homogeneous mixture of the recited constituents, for example in the form of sheets or hides, may be thermoformed under pressure into a desired shape. By using a press, this method may be capable for example of producing sheet products of defined thickness. By using the abovementioned blowing agents, methods known per se can be used to produce foams.

The present invention further provides the use of cellulose ester preparations according to the present invention in the manufacture of flame-retarded mouldings, sheets, films, coatings, paints and fibres, and also the mouldings, sheets, films, coatings, paints and fibres thus obtained, and further-processing products thereof.

The extrusion- or injection-moulded articles, solid sheet products, cellular sheet products, sheet foams, sheets, films, coatings, paints and fibres thus obtained may be used in the electrical and electronics sector, for example in housing parts, switches or plugs, in civil engineering, for example as insulants, and in vehicle construction, for example in interior trim, sill plates, foot mats, trunk carpets, seat covers, carbody parts, spoilers or exterior trim strips.

The present invention further provides the use of mouldings according to the present invention in the manufacture of housing parts switches, plugs, insulars, interior trim, sill plates, foot mats, trunk carpets, seat covers, carbody parts, spoilers or exterior trim strips.

Embodiments of the invention will now be more particularly described by way of example in that they shall not be construed as limiting the invention.

### EXAMPLES

Parts hereinbelow are by weight.

Preparing the Phosphorus-Containing Propionic Ester of Formula (I) where X=O, R=H, A=O, Z=n-butyl and n=1

n-Butyl 6-oxo-6H-dibenzo[c,e][1,2]oxaphosphotine-6-propionate was prepared as per the method of Organic Letters 2005, Vol. 7, No. 5, Supplementary Information S8, by reacting 6H-dibenzo[c,e][1,2]oxaphosphorine 6-oxide with n-butyl acrylate to obtain as colourless liquid having a viscosity of 6500 mPas at 23° C.

Production of Cellulose Ester Preparations

TABLE 1
Raw materials used for production of cellulose ester preparations

| Component | Designation | Description |
|---|---|---|
| A | cellulose acetate | crude cellulose acetate, unmodified, DS = 2.5 acetyl |
| | | groups per anhydroglucose unit. |
| B | Vulkanox BHT | antioxidant |
| C | acetone | solvent |
| F1 | Disflamoll ® TP | triphenyl phosphate, flame retardant and plasticizer, |
| | | from Lanxess |
| F2 | Levagard ® TP LXS 51078 | phosphate ester preparation based on diethylene glycol |
| | | bis(diethyl phosphate), flame retardant and plasticizer, |
| | | from Lanxess |
| F3 | RDP | resorcinol bis(diphenyl phosphate), flame retardant and |
| | | plasticizer, from Yoke |
| F4 | Uniplex FRP 45 | tetrabrominated bis(2-ethylhexyl) phthalate, flame |
| | | retardant and plasticizer, from Lanxess |
| F5 | phosphorus-containing | flame retardant and plasticizer, prepared as described |
| | propionic ester of | above |
| | formula (I) where X = O, | |
| | R = H, A = O, Z = n-butyl | |
| | and n = 1 | |

Production of Solutions of Cellulose Ester Preparations

Solvent, flame retardant and antis as per table 1 are initially charged in a glass flask in the quantitative ratios reported in table 2. As the glass flask is gently heated to about 40 to 50° C. in a water bath, the cellulose acetate powder quantity reported in table 2 is added with constant stirring to prevent formation of gel clumps. The solution obtained after about 5 hours is clear, free from particles and useful for production of cast sheets.

Processing of Cellulose Ester Preparation Into Sheets

About 150 g of the solution are poured into a horizontal 20×20 cm casting mould open at the top. The solvent is evaporated slowly, over as period of not less than one day. The sheet formed is removed from the mould and dried in a hot air oven at 60 to 70° C. to remove residual solvent. The drying process can take several hours, it is complete once the sheet samples are solvent-free, i.e. stop losing weight.

Test specimens, for example dumbbell shapes, are die-cut out of the cellulose ester sheets. The test specimens were homogeneous, i.e. bubble-free and of uniform thickness. The test specimens are preferably taken from the centre of the sheet.

Processing of Cellulose Ester Preparation by Thermoforming

An hydraulic press may be used to thermoform cellulose ester sheets at 170-180° C. into 2 mm thick, transparent and bubble-free sheet products. Test specimens for flammability tests by the UL 94 method are sawn from the sheet products.

Determination of Flame Retardancy

The cellulose ester preparations are tested for fire resistance by the method of UL 94 (“Standard Test for Flammability of Plastic Materials for Parts in Devices and Applications” of Underwriters Laboratories). Five test specimens measuring about 125*12.5*2.0 mm are in each case clamped vertically into a holder and subjected in succession to two applications of a small burner flame. No test specimen shall burn to the holding clamp.

If the sum total of the burning times after flame application in as series of five test specimens from one recipe is less than 50 s, no test specimen has a burning time of more than 10 s after flame application, no test specimen has an afterglow time of more than 30 s and no test specimen drips flaming particles, then the recipe is assigned to the class V-0.

If the sum total of the burning times after flame application in a series of five test specimens from one recipe is less than 250 s, no test specimen has a burning time of more than 30 s after flame application, no test specimen has an afterglow time of more than 60 s and no test specimen drips flaming particles, then the recipe is assigned to the class V-1.

If the sum total of the burning times after flame application in a series of five test specimens from one recipe is less than 250 s, no test specimen has a burning time of more than 30 s after flame application, no test specimen has an afterglow time of more than 60 s but the specimens drip flaming particles, then the recipe is assigned to the class V-2.

Test Results For Cellulose Ester Preparations

TABLE 2
Composition (parts by weight) and test results of Inventive
Example B1 and of non-inventive Comparative Examples V1
to V4 for cellulose ester preparations.

| | Example | | | | |
|---|---|---|---|---|---|
| | V1 | V2 | V3 | V4 | B1 |
| A | 70 | 70 | 70 | 70 | 70 |
| B | 0.3 | 0.3 | 0.3 | 0.3 | 0.3 |
| C | 270 | 270 | 270 | 270 | 270 |
| F1 | 30 | | | | |
| F2 | | 30 | | | |
| F3 | | | 30 | | |
| F4 | | | | 30 | |
| F5 | | | | | 30 |
| UL 94 class | V-2 | none | none | V-2 | V-2 |
| ash residue (%) | 4.6 | 18.5 | 20.2 | 6.1 | 28.1 |
| Shore D | 69.6 | 65.4 | 77.5 | 68.7 | 78.3 |

Determination of Tensile Strength

The determination is carried out in accordance with DIN EN ISO 527 on a Lloyd tensile tester with laser extensometer using in each case five S 2 dumbbell specimens die-cut out of sheets.

Determination of Shore Hardness

The determination is carried out using a Zwick durometer in accordance with the manufacturer's instructions for the T 48 electronic unit. For measurement, the sheets were stacked together to form test specimens about 5 mm in thickness.

Determination of Sheet Homogeneity

Sheet homogeneity was determined by comparing the sheets in respect of transparency, streaks, uniformity of thickness and surface texture. The qualitatively best sheet is ranked 1, the worst 5.

Determination of Light Transmission

The light transmission of the sheets was investigated using a Lambda 12 UV/VIS spectrometer from Perkin Elmer. Transmission was measured here in per cent in 20 nm steps from 400 to 1100 nm. The transmissions measured across the full wavelength range were averaged and the average transmission value was used for comparing the individual sheet samples.

Determination of Thermal Ageing

Thermal ageing was determined in a Mathis oven at 200° C. The sheet test specimens were evaluated after 50 min in the oven. Since some sheets were deformed and nonuniformly discoloured after ageing, colorimetric measurement could be carried out. Instead, the test specimens were ranked according to increasing discoloration. The least discoloured sheet is ranked 1, the most discoloured sheet 5.

Determination of UV Ageing

The UV ageing test was performed on the sheets in a Suntest CPS+ at 500kJ/m² for 48 hours. A Minolta Chromameter CR 400 was used for evaluation. The L a b values of the sheet samples were measured before and after ageing. The colour change was determined as ((L₁−L₀)²+(a₁−a₀)²+(b₁−b₀)²)^{0.5}

Determination of Thermal Stability by DSC

The thermal stability of the cellulose ester preparations was determined using DSC. Sheet samples were heated under nitrogen from room temperature to 500° C. at as rate of 10° C./min. The onset of any significant reaction/degradation of the material was taken to be the first significant peak above the typical processing temperature of about 200° C. for cellulose esters.

Determination of Thermal Stability by TGA

The thermal stability of the cellulose ester preparations was determined using TGA. Sheet samples were heated under nitrogen from room temperature to 500° C. at a rate of 10° C./min. Above their processing temperatures, the cellulose ester preparations start to undergo degradation reactions which lead to weight loss. The weight loss at 305° C. was chosen as basis for comparing stability.

Determination of Ash Residue

The ash residue is determined by weighing sheet samples before and after storage in a muffle kiln. To this end, sheet samples are weighed into a porcelain crucible, placed in the muffle kiln at 500° C. for one hour and then reweighed.

TABLE 3
Composition (parts by weight) and test results of Inventive
Example B2 and of non-inventive Comparative Examples
V5 to V8 for cellulose ester preparations.

| | Example | | | | |
|---|---|---|---|---|---|
| | V5 | V6 | V7 | V8 | B2 |
| A | 30 | 30 | 30 | 30 | 30 |
| B | 0.5 | 0.5 | 0.5 | 0.5 | 0.5 |
| C | 168 | 168 | 168 | 168 | 168 |
| F1 | 15 | | | | |
| F2 | | 15 | | | |
| F3 | | | 15 | | |
| F4 | | | | 15 | |
| F5 | | | | | 15 |
| tensile strength (N/mm2) | 32.5 | 17.4 | 32.6 | 9.6 | 26.8 |
| Shore A | 100 | 99 | 99 | 88 | 97 |
| sheet homogeneity | 2 | 1 | 4 | 5 | 3 |
| (ranked by quality) | | | | | |
| light transmission (%) | 82 | 64 | 2.9 | 1.2 | 90 |
| thermal ageing | 2 | 5 | 1 | 3 | 4 |
| (ranked by quality) | | | | | |
| colour change after UV ageing | 18 | 7.4 | 29 | 52 | 5.3 |
| thermal stability by DSC | 330 | 290 | 318 | 339 | 336 |
| (peak in ° C.) | | | | | |
| thermal stability by TGA | 23.7 | 75.2 | 8.1 | 18.9 | 14.1 |
| (weight loss in %) | | | | | |
| ash residue (%) | 1.0 | 2.8 | 2.2 | 0.0 | 2.1 |

Evaluation of Results

All the F1 to F5 plasticizer-cum-flame retardants tested were highly compatible with cellulose acetate. The cellulose acetate preparations obtained therefrom were readily processible into films and, by thermoforming, into sheet products. The test results in tables 2 and 3 make it possible to compare the Inventive Cellulose Ester Preparations based on F5 with the prior art preparations based on F1 (triphenyl phosphate, cf, U.S. Pat. No. 1,981,312), F2 (phosphate ester preparation based on diethylene glycol bis(diethyl phosphate), cf. U.S. Pat. No. 2,782,128), F3 (resorcinol bis(diphenyl phosphate), cf. WO 9205219 A1) and F4 (tetrabrominated bis(2-ethylhexyl) phthalate, cf. U.S. Pat. No. 2,062,403).

Fire Properties:

According to table 2, Inventive Cellulose Ester Preparation B1, comprising the phosphorus-containing propionic acid derivative of formula (I), achieves the UL 94 class V-2. This means that B1 exhibits the same level of flame retardancy as Comparative Examples V1, comprising (Disflammoll® TP), and V4, comprising P4 (Uniplex FRP 45).

Thermal Stability:

As is apparent from table 3, inventive Cellulose Ester Preparation B2, comprising the phosphorus-containing propionic acid derivative of formula (I), exhibits surprisingly high stability on heating. The DSC shows a decomposition peak at a temperature that is higher than that of the decomposition peak of preparation V5, comprising F1 (Disflamoll® TP), and is only exceeded by V8, comprising F4 (Uniplex FRP 45), by 3° C.

The TGA shows Inventive Cellulose Ester Preparation B2, comprising phosphorus-containing propionic acid derivative of formula (I), to have a relatively low 305° C. weight loss, only preparation V7, comprising F3 (RDP), being superior in this respect.

Other Properties:

Inventive Cellulose Ester Preparation B2, comprising the phosphorus-containing propionic acid derivative of formula (1), processes into a transparent film, and shows the highest light transmission of all the preparations tested. Of all the preparations tested preparation B2 also exhibits the smallest colour change after UV ageing.

Summary:

What is surprising is the finding that the phosphorus-containing, propionic acid derivatives of formula (I) act in the preparations of the present invention not just as flame retardants, but at the same time also as plasticizers. No addition of further plasticizers and/or flame retardants is required, but may be included, if desired, for additional properties.

Cellulose acetate is thus easy to process with the phosphorus-containing propionic acid derivative of formula (1) into the cellulose ester preparations of the invention. These preparations are free from undesirable halogenated or aryl phosphate-containing plasticizers. At the same time, their physical properties are equivalent to and in some aspects even superior to the properties of other preparations.

Thus they achieve the same UL 94 flame-retardancy classification as cellulose ester preparations comprising F1 (Disflamoll® TP) or F4 (Uniplex FRP 45). In addition, the preparations according to the present invention have high thermal stability. The surprisingly lower level of discolouration after UV ageing and the high transmissivity testify to the superiority of the cellulose ester preparations according to the present invention over the comparative preparations in applications calling for transparency.

What is claimed is:

1. A cellulose ester preparation comprising:
a) one or more cellulose esters, and
b) one or more phosphorus-containing propionic acid derivatives of formula (I) 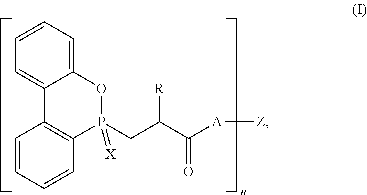
where
X represents oxygen or sulphur,
R represents hydrogen or methyl,
A represents oxygen or NH,
Z represents an n-valent saturated, straight-chain or branched, aliphatic hydrocarbyl moiety of 1-20 carbon atoms which is optionally interrupted by one or more heteroatoms from the series oxygen and sulphur, or an n-valent 5- or 6-membered heterocyclic ring which contains one to three nitrogen atoms as heteroatoms and is optionally substituted by one or more identical or different substituents, and n represents an integer from 1 to 4.

2. The cellulose ester preparation according to claim 1, wherein:
X represents oxygen,
R represents hydrogen, and
A represents oxygen.

3. The cellulose ester preparation according to claim 1, wherein
Z represents an n-valent saturated, straight-chain or branched, aliphatic hydrocarbyl moiety of 1 to 6 carbon atoms which is optionally interrupted by one or two oxygen atoms, or an n-valent 5- or 6-membered heterocyclic ring which contains one to three nitrogen atoms as heteroatoms and is optionally substituted by one to three identical or different substituents.

4. The cellulose ester preparation according to claim 1, wherein:
a) n represents 1, and
Z represents methyl, ethyl, n-propyl, isopropyl, n-butyl, isobutyl, 2-ethylhexyl, isooctyl, n-nonyl, isononyl, 2-propylheptyl, n-decyl or isodecyl, and/or
b) n represents 2, and
Z represents —CH₂CH₂—, —CH₂CH₂CH₂—, —CH₂CH(CH₃)—, —CH₂CH₂CH₂CH₂—, —CH₂CH₂CH(CH₃)—, —CH₂C(CH₃)CH₂—, —CH₂CH₂CH₂CH₂CH₂CH₂—, or —CH₂CH₂—O—CH₂CH₂—, and/or
c) n represents 3, and
Z represents (—CH₂)₃CCH₃ or 1,3,5-tris(ethylene)-1,3,5-triazine-2,4,6-trione, and/or
d) n represents 4, and
Z represents (—CH₂)₄C.

5. cellulose ester preparation according to claim 1, wherein the cellulose ester a)) comprises one or more esters selected from the group consisting of cellulose acetate, cellulose triacetate, cellulose propionate, cellulose butyrate, cellulose acetate propionate, cellulose acetate butyrate, cellulose acetate phthalate, carboxymethylcellulose acetate, and carboxymethyl-cellulose butyrate.

6. The cellulose ester preparation according to claim 1, wherein the cellulose ester a) has a degree of substitution of 1.0-3.0 acyl groups per anhydroglucose unit.

7. The cellulose ester preparation according to claim 1, wherein the preparation contains 5-60 parts by weight of the one or more phosphorus-containing propionic acid derivatives of formula (I) based on 100 parts by weight of the cellulose ester.

8. The cellulose ester preparation according to claim 1, wherein the preparation contains 10 to 50 parts by weight of the one or more phosphorus-containing propionic acid derivatives of formula (I) based on 100 parts by weight of the cellulose ester.

9. The cellulose ester preparation according to claim 1, further comprising one or more auxiliary or added-substance materials selected from the group of plasticizers, UV stabilizers, antioxidants, thermal stabilizers, colorants, fillers, polymers, blowing agents, scents, biocides, pesticides, processing aids, lubricants and flame retardants.

10. The cellulose ester preparation according to claim 1, wherein the preparation comprises:
the one or more one or more cellulose esters,
the one or more phosphorus-containing propionic acid derivatives of formula (I), and
one or more organic solvents.

11. The cellulose ester preparation according to claim 10, wherein the one or more organic solvents are selected from methanol, ethanol, isopropanol, acetone, butatione, ethyl acetate, butyl acetate, dichloromethane, and toluene.

12. The cellulose ester preparation according to claim 1, wherein:
the preparation contains 10 to 50 parts by weight or the one or more phosphorus-containing propionic acid derivatives of formula (I) based on 100 parts by weight of the cellulose ester;
the cellulose ester a) comprises:
one or more esters selected from the group consisting of cellulose acetate, cellulose triacetate, cellulose propionate, cellulose butyrate, cellulose acetate propionate, cellulose acetate butyrate, cellulose acetate phthalate, carboxymethylcellulose acetate, and carboxymethylcellulose butyrate, and
a degree of substitution of 1.0-3.0 acyl groups per anhydroglucose unit;
X and A represent oxygen;
R represents hydrogen; and
Z represents an n-valent saturated, straight-chain or branched, aliphatic hydrocarbyl moiety of 1 to 6 carbon atoms which is optionally interrupted by one or two oxygen atoms, or an n-valent 5- or 6-membered heterocyclic ring which contains one to three nitrogen atoms as heteroatoms and is optionally substituted by one to three identical or different substituents.

13. A phosphorus-containing propionic acid derivative of formula (I) 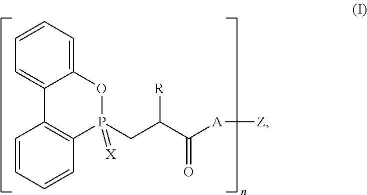
wherein:
X represents oxygen or sulphur,
R represents hydrogen or methyl.
A represents oxygen or NH,
Z represents an n-valent saturated, straight-chain or branched, aliphatic hydrocarbyl moiety of 1-20 carbon atoms which is optionally interrupted by one or more heteroatoms from the series oxygen and sulphur, or an n-valent 5- or 6-membered heterocyclic ring which contains one to three nitrogen atoms as heteroatorns and is optionally substituted by one or more identical or different substituents, and
n represents an integer from 1 to 4.

14. The phosphorus-containing propionic acid derivative of claim 13, wherein:
X represents oxygen,
R represents hydrogen,
A represents oxygen,
n represents 1, and
Z represents 2-ethythexyl, isooctyl, n-nonyl, isononyl, 2-propylheptyl, n-decyl or isodecyl.

15. The phosphorus-containing propionic acid derivative of claim 13, wherein:
X represents oxygen,
R represents hydrogen,
A represents oxygen,
n represents 2, and
Z represents —CH₂CH₂—, —CH₂CH₂CH₂—, —CH₂CH(CH₃)—, —CH₂CH₂CH₂CH₂—, —CH₂CH₂CH(CH₃)—, —CH₂C(CH₃)CH₂—, —CH₂CH₂CH₂CH₂CH₂CH₂—, or —CH₂CH₂—O—CH₂CH₂—.

16. A process for producing as cellulose ester preparation according to claim 1, the process comprising mixing together the one or more cellulose esters and the one or more phosphorus-containing propionic add derivatives of formula (I), optionally one or more solvents and optionally one or more auxiliary and/or added-substance materials are mixed together.

17. The process for producing a cellulose ester preparation according to claim 16, further comprising mixing one or more solvents and optionally one or more auxiliary and/or added substance materials together with the one or more cellulose esters and the one or more phosphorus-containing propionic acid derivatives of formula (I).

18. A method of producing a flame retardant with plasticizing properties, the method comprising mixing a phosphorus-containing propionic acid derivative of formula (I) in a cellulose ester preparation, wherein formula (I) is 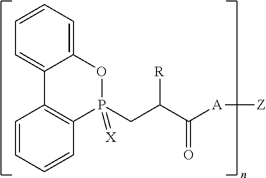
where
X represents oxygen or sulphur,
R represents hydrogen or methyl,
A represents oxygen or NH,
Z represents an n-valent saturated, straight-chain or branched, aliphatic hydrocarbyl moiety of 1-20 carbon atoms which is optionally interrupted by one or more heteroatoms from the series oxygen and sulphur, or an n-valent 5- or 6-membered heterocyclic ring which contains one to three nitrogen atoms as heteroatoms and is optionally substituted by one or more identical or different substituents, and
n represents an integer from 1 to 4.

19. A name retardant moulding, sheet, film, coating, paint or fibre comprising the cellulose ester preparation according to claim 1.

20. Flame retardant articles of manufacture produced from the flame retardant moulding, sheet, film, coating, paint or fibre of claim 19, wherein the articles of manufacture include housing parts, switches, plugs, insulants, interior trim, sill plates, foot mats, trunk carpets, seat covers, carbody parts, spoilers, and/or exterior trim strips.
